(19) United States
(12) Patent Application Publication
(10) Pub. No.: US 2008/0115073 A1
(43) Pub. Date: May 15, 2008

(54) Method and Apparatus for Remote Display of Drawn Content

(76) Inventors: Shawn Erickson, Santa Barbara, CA (US); Bradley Kohn, Santa Barbara, CA (US); Andrew Duncan, Santa Barbara, CA (US)

Correspondence Address: Goodwin Procter LLP, Exchange Place, Boston, MA, 02109, US

(21) Appl. No.: 11/871,032

(22) Filed: Oct. 11, 2007

Related U.S. Application Data
(63) Continuation-in-part of application No. 10/908,807, filed on May 26, 2005.

(51) Int. Cl. G06F 3/048

(52) U.S. Cl. 715/766

(57) ABSTRACT

Method and system for the remote display of drawn content. In one embodiment, a drawing window is created at a source device, a location of a system mouse event is observed at a viewer device and the transparency of a pixel in the drawing window at the source device at the location of the mouse event is manipulated. The pixel may be cleared, thereby making the location of the mouse event transparent, which may send the mouse event to a non-transparent window immediately below the drawing window.

### CROSS-REFERENCE TO RELATED APPLICATIONS

The present application claims the benefit of co-pending U.S. utility application Ser. No. 10/908,807, filed on May 26, 2005, the entire disclosure of which is incorporated by reference as if set forth in its entirety herein.

### TECHNICAL FIELD

The invention generally relates to screen sharing. More particularly, the invention relates to methods and systems for manipulating a specific area of the shared screen.

### BACKGROUND

One example of a screen sharing application is the GOTOMEETING service offered for use by Citrix Online Division of Santa Barbara, Calif. GOTOMEETING allows for a host operating a first computer to organize online meetings for a plurality of viewers each operating their own remote computer. With the GOTOMEETING service, these remote viewers can view any application running on the host's computer in real time.

During a screen sharing session, it is often desirable to allow a viewer to interact with application programs or the operating system executing on the viewer's computer while the viewer continues to view drawn content originating with the host's or other viewers' computers. This can require drawing content to a viewer's display subject to the following constraints:
The drawn content must not prevent, intercept or block mouse events (i.e., mouse movements or clicks) originating at the viewer's computer from being received by applications or the operating system executing on the viewer's computer and displayed below the drawn content.
Mouse events originating at the viewer's computer that would normally be received by applications or the operating system executing on the viewer's computer must be selectively intercepted and blocked while new drawn content is being displayed on the viewer's computer using the mouse.
Drawn content must not be lost if the display content originating on the viewer's computer and appearing below the drawn content is updated.
Certain of the drawn content may be erased to restore the display of the application or operating system executing on the viewer's computer and appearing below the display of content, without erasing all drawn content.

Therefore, there is a need for methods and systems for manipulating a specific area of the shared screen in a shared display environment, while meeting these restrictions.

### SUMMARY OF THE INVENTION

The present invention relates to methods and systems for the remote display of drawn content. Embodiments of the present invention allow a remote viewer of drawn content to interact with application programs or the operating system executing on the viewer's computer while the viewer continues to view drawn content originating at a host's or other viewers' computers.

In general, in one aspect, the invention provides a method for the remote display of drawn content. The method includes creating, at a source device, a drawing window defining a region for the display of drawn content. The method further includes providing a copy of the drawing window to at least one viewer device and observing a location of a system mouse event occurring at a viewer device. The method also includes manipulating the transparency of at least one pixel in the drawing window at the location of the mouse event when the location of the mouse event is within the drawing window.

In one embodiment, the drawing window may be at least semi-transparent. In another embodiment, manipulating a pixel at the location of the mouse event may comprise clearing a single pixel at the location of the mouse event, causing the pixel to become temporarily transparent. In these embodiments, information concerning the mouse event is provided to a non-transparent window appearing immediately below the drawing window in Z-order.

In other embodiments, manipulating a pixel at the location of the mouse event may comprise drawing a single pixel at the location of the mouse event. This may cause the pixel to become temporarily opaque. In these embodiments, information concerning the mouse event may be provided to the drawing window. In still other embodiments, the mouse event may be used to draw new content in the drawing window.

In general, in another aspect, the invention features a system for the remote display of drawn content. The apparatus includes a drawing window created at a source device which defines a region for the display of drawn content. The system also includes a copy of the drawing window provided to at least one viewer device and a mouse event tap for observing a location of a system mouse event occurring at a viewer device. Finally, a display element is included for manipulating the transparency of at least one pixel in the drawing window at the location of the mouse event when the location of the mouse event is within the drawing window.

In one embodiment, the drawing window may be at least semi-transparent. In another embodiment, manipulating a pixel at the location of the mouse event may comprise clearing a single pixel at the location of the mouse event, causing the pixel to become temporarily transparent. In these embodiments, information concerning the mouse event is provided to a non-transparent window appearing immediately below the drawing window in Z-order.

In other embodiments, manipulating a pixel at the location of the mouse event may comprise drawing a single pixel at the location of the mouse event. This may cause the pixel to become temporarily opaque. In these embodiments, information concerning the mouse event may be provided to the drawing window. In still other embodiments, the mouse event may be used to draw new content in the drawing window.

In general, in yet another aspect, the invention features a computer-readable storage medium containing executable instructions. The set of instructions includes instructions for creating, at a source device, a drawing window defining a region for the display of drawn content. The set of instructions also includes instructions for providing a copy of the drawing window to at least one viewer device and instructions for observing a location of a system mouse event occurring at the viewer device. The set of instructions further includes instructions for manipulating the transparency of at least one pixel in the drawing window at the location of the mouse event when the location of the mouse event is within the drawing window.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagrammatic view of one embodiment of a networked system having multiple viewer devices in communication with a source device to provide a screen sharing environment.

FIGS. 2A and 2B are block diagrams depicting embodiments of computers useful in connection with the present invention.

FIGS. 3A and 3B are screen shots of desktops of a source device and a viewer device, respectively, according to principles of the invention.

FIGS. 4A and 4B are screen shots of desktops of a source device and a viewer device, respectively, using an embodiment of drawn content according to principles of the invention.

FIG. 5 is a graphical representation of a mouse event and drawing window on a viewer device according to principles of the invention.

FIG. 6 is a block diagram of an embodiment of a system for remote display of drawn content in a shared display environment according to principles of the invention.

FIG. 7 is a flow chart of an embodiment of a method of displaying drawn content according to principles of the invention.

FIG. 8 is a diagrammatic view of a system for sharing screen data.

### DESCRIPTION

In brief overview, embodiments of the present invention allow viewers of a screensharing application to interact with application programs or the operating system executing on the viewer's computer while the viewer continues to view drawn content originating at a host's or other viewers' computers.

Certain embodiments provide this functionality by manipulating the transparency of a pixel in a drawing window of a viewer device that is participating in a screen sharing session with a source device. As used herein, a “drawing window” refers to a transparent window, either a fully transparent window or a partially-transparent window (i.e., a translucent window). To manage mouse events at the viewer device, a pixel may be either cleared or drawn in the drawing window at the source device at the location of the mouse event, thereby causing the location of the mouse event to temporarily become transparent or opaque, respectively.

Certain embodiments of the invention also use low-level mouse hooks to intercept mouse events before they are passed to other applications in the viewer's computing environment. The invention generates and positions a drawing window for the drawn content. As the drawn content moves, the position of the drawing window itself may be updated so that the drawing window remains substantially beneath the drawn content. The drawing window can also be sized to substantially cover the viewer's display. Embodiments of the present invention operate so as to maintain the correct Z-order ordering of the windows of viewer's computing environment: the drawing window is associated with the drawn content such that the drawing window is on top (i.e., in front) of the other windows on the desktop of the viewer's display, but below (i.e., behind) the windows of the screensharing application.

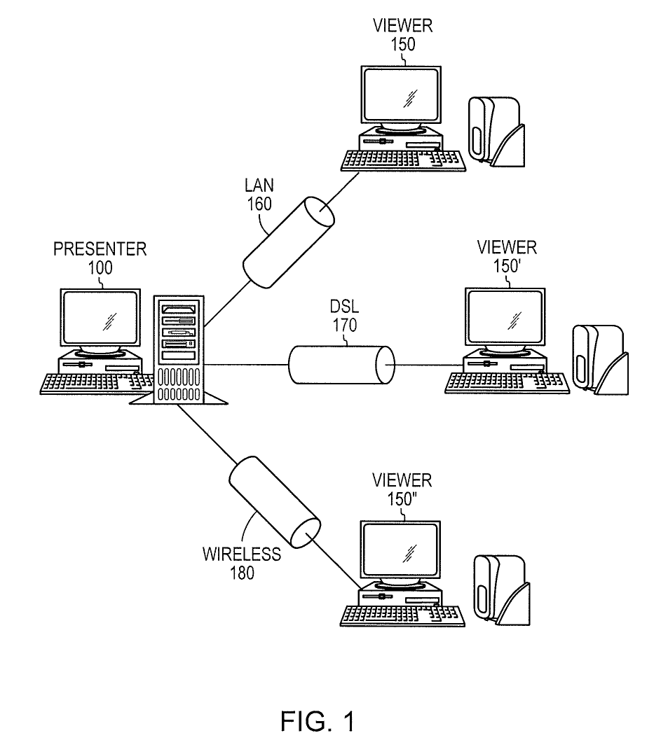

Referring now to FIG. 1, a networked system that permits a screen sharing environment has a source device 100 (also referred to as a presenter node, presenter system, host node, or host system) in communication with a number of viewer devices 150, 150′, 150″ (also referred to as viewer nodes or viewer systems) is depicted. As shown in FIG. 1, the viewer devices 150, 150′, 150″ may communicate with the source device 100 via networks of differing bandwidth. In the embodiment shown in FIG. 1 viewer device 150 communicates with the source device 100 via a high-bandwidth network 160, such as a local area network (LAN). Viewer device 150″ communicates with the source device 100 via a low-bandwidth network 180, such as a wireless network. Viewer device 150′ communicates with the source device 100 via a network 170 having bandwidth between the low-bandwidth network 180 and the high-bandwidth network 160, such as a Digital Subscriber Line (DSL) connection. Although only one source device 100 and three viewer devices 150, 150′, 150″ are depicted in the embodiment shown in FIG. 1, it should be understood that the system may provide multiple ones of any or each of those components. For example, in one embodiment, the system includes multiple, logically-grouped source devices 100, each of which may be available to provide data to a viewer device 150, 150′, 150″. In these embodiments, the logical group of source devices 100 may be referred to as a “server farm” or “content farm.” In other embodiments, the source device 100 is a multi-user server having a virtual frame buffer, i.e., a presentation server.

The network connections 160, 170, 180 between the viewer devices 150, 150′, 150″ and the source device 100 can be local area networks (LAN), metropolitan area networks (MAN), or a wide area network (WAN) such as the Internet. The source device 100 and the viewer devices 150, 150′, 150″ may connect to the networks 160, 170, 180 through a variety of connections including standard telephone lines, LAN or WAN links (e.g., T1, T3, 56 kb, X.25), broadband connections (ISDN, Frame Relay, ATM), and wireless connections. Connections between the source device 100 and the viewer devices 150, 159′, 150″ may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections). Although shown in FIG. 1 as separate networks, networks 160, 170, 180 may be combined in a single physical network.

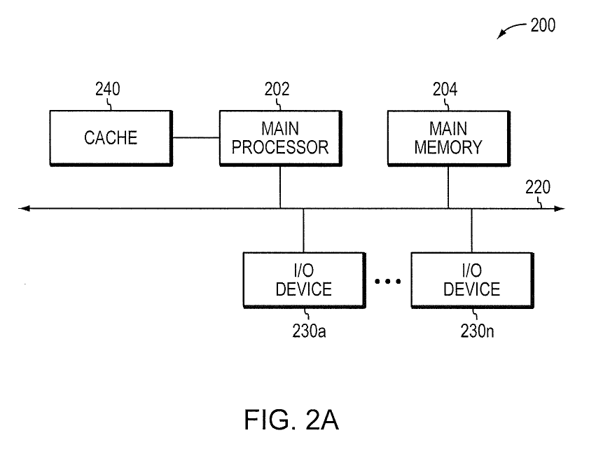

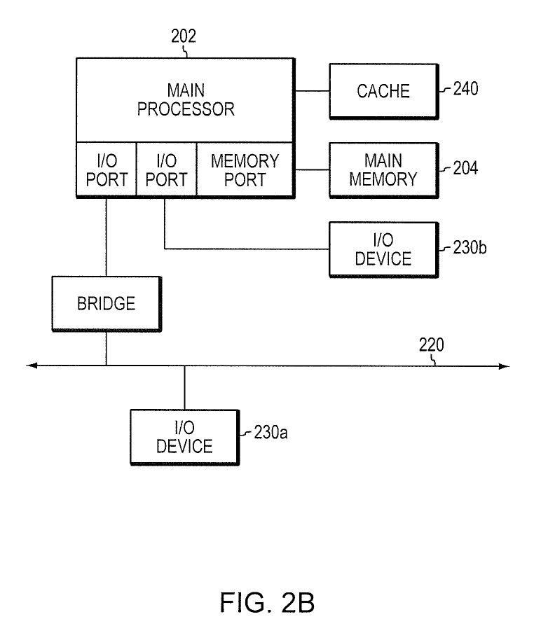

In many embodiments, the source device 100 and the viewer devices 150, 150′, 150″ are provided as personal computer or computer servers, of the sort manufactured by the Hewlett-Packard Corporation of Palo Alto, Calif. or the Dell Corporation of Round Rock, Tex. FIGS. 2A and 2B depict block diagrams of a typical computer 200 useful as the source device 100 and the viewer devices 150, 150′, 150″. As shown in FIGS. 2A and 2B, each computer 200 includes a central processing unit 202, and a main memory unit 204. Each computer 200 may also include other optional elements, such as one or more input/output devices 230a-230n (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM3800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athlon 64 FX, the AMD Athlon, or the AMD Duron processor, manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), Synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. Typical operating systems include: Microsoft Windows, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

In some embodiments the viewer device 150, 150′, 150″ is a mobile device, such as a JAVA-enabled cellular telephone or personal digital assistant (PDA), such as the i50sx, i55sr, i58sr, i85s, i88s, i90c, i95cl, or the im11000, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In other embodiments in which the client device 140 is mobile, it may be a personal digital assistant (PDA), such as the Tungsten W, the VII, the VIIX, the i705, or a combination PDA/telephone device such as the Treo 180, Treo 270 or Treo 600, all of which are manufactured by palmOne, Inc. of Milpitas, Calif.

In these embodiments, the viewer devices 150, 150′, 150″ connect to the source device 100 using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

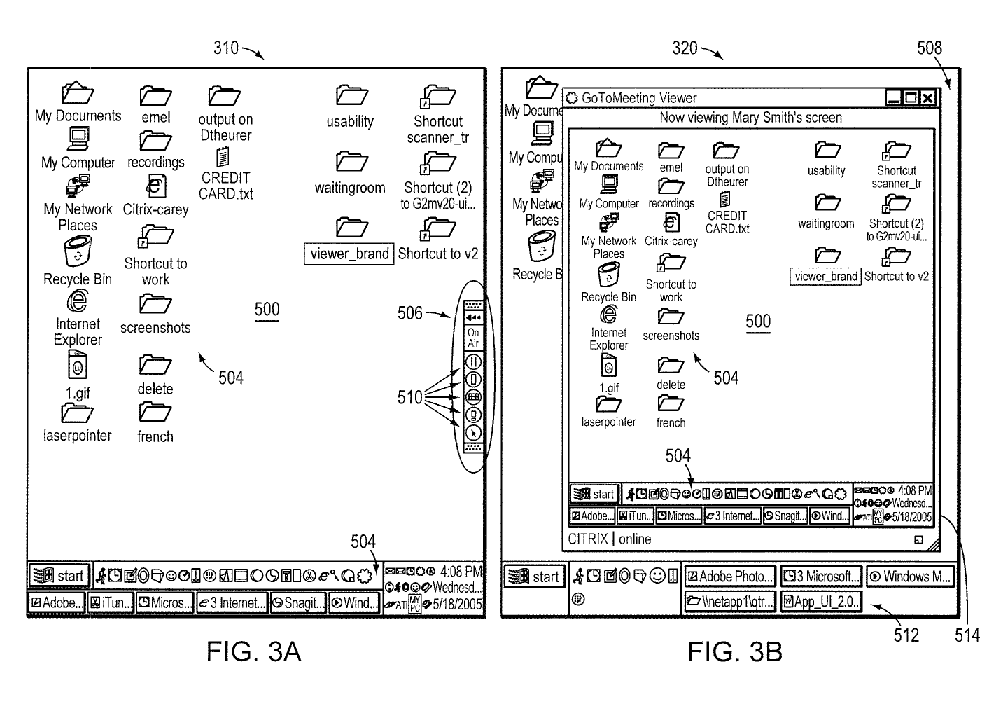

With reference to FIG. 3A, a screen shot depicts an embodiment of a source device display 310 that is sharing display data representing a desktop environment 500 with a viewer device 150. In brief overview, the desktop environment 500 of the source device 100 includes icons, elements (e.g., toolbars, menus, and application windows), and other items that are commonly referred to as desktop environment elements 504. During a screen sharing session, the desktop environment 500 of the source device 100 includes a control panel 506 that is part of a screen sharing application or service executing on the source device 100. The control panel 506 includes various buttons 510 that provide control functionality and status of the screen sharing application. For example, the buttons 510 allow a user of the source device 100 to determine what elements of the desktop environment 500 to share, which viewer systems 150 can view the desktop environment 500, indicating whether or not the desktop environment 500 is being displayed, and tools to annotate the desktop environment.

The user of the source device 100 may choose to share the desktop environment 500 with the user of the viewer device 150, which can include all or some of the desktop environment elements 504. In one embodiment, the user of the source device 100 chooses to share the display 310 to enable collaboration with the user of the viewer device 150. In another embodiment, the user of the source device 100 chooses to share the display 310 to enable training or troubleshooting. It should be understood that in some embodiments, the source device 100 may pass control to the viewer device 150. As such, the roles of source device 100 and viewer device 150 are reversed. In other embodiments, the source device 100 may share display data with more than viewer device 150, 150′, 150″.

With reference to FIG. 3B, a screen shot depicts an embodiment of a viewer device display 320 that is receiving shared display data representing the desktop environment 500 of the source device 100. A desktop environment 508 of the viewer device 150 includes icons, elements (e.g., toolbars, menus, and application windows), and other items that are commonly referred to as viewer desktop environment elements 512. During a screen sharing session, the desktop environment 508 displays the shared desktop environment 500 of the source device 100, including those desktop environment elements 504 chosen for sharing, in an application window 514. It should be noted that the control panel 506 of the screen sharing application is not shown to the viewer device 150. However, the functionality of the screen sharing application may allow for the source device 100 to become a viewer device 100 by allowing a viewer device 150 to share its respective desktop environment 508. In another embodiment, only portions of the functionality of the control panel 506 are provided and displayed in the application window 514. For example, annotation tools are provided to the viewer system 150.

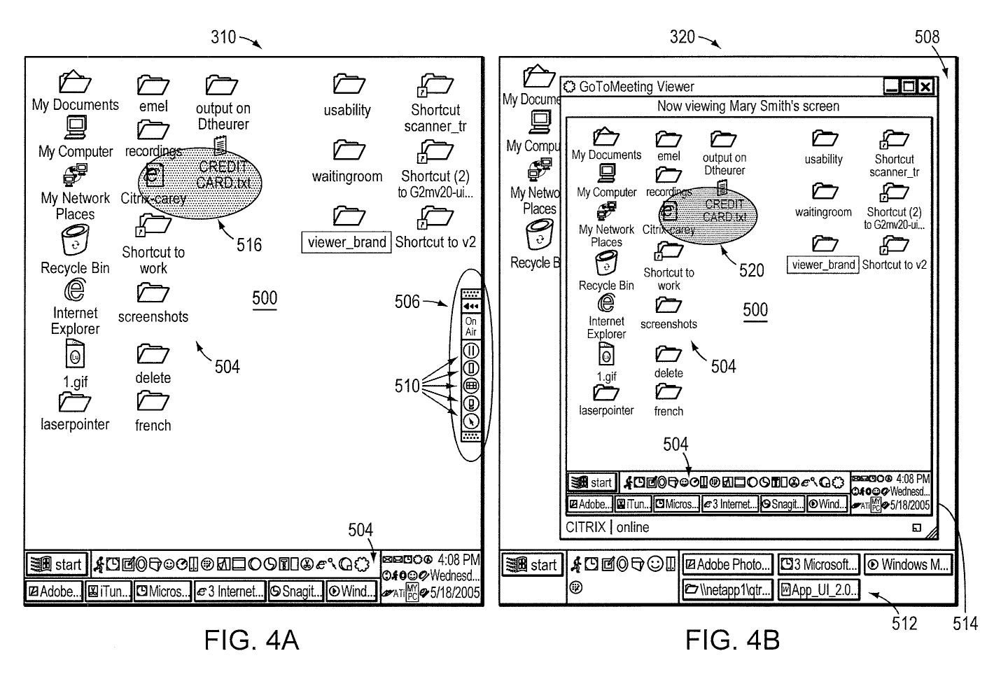

With reference to FIGS. 4A and 4B, a screen shot of each respective desktop environment 500 and 508 shows respective drawn content 516, 520 that covers a respective area of the shared desktop environment 500. In one embodiment, the drawn content 516 may be in the shape of a circle as shown in FIGS. 4A and 4B. The drawn content 516 may be added to the shared desktop environment 500 by a viewer 150 using an annotation tool (i.e., a pen tool or highlighter tool). The annotation added by the viewer (here, shown by a circle, 516) may be displayed on the source device display 310 and replicated to each viewer device display 320, as shown by the drawn content 520 on the viewer display 320. In one embodiment, the drawn content 516 of the display 310 of the source device 100 is captured and transmitted as part of the screen data. Said another way, the drawn content 516 is broadcast from the source device 100 to each viewer device 150 and rendered into the shared desktop environment 500 of the viewer device 150. In one embodiment, the translucent version of the drawn content 516 is always transmitted to the viewer device 150. In another embodiment, the drawn content 516 of the source device 100 is not transmitted as part of the shared screen data, but instead the drawn content 520 of the viewer device 150 is replaced by the drawn content 516 on that system. Said another way, the source device 100 and each viewer device 150 use its respective drawn content.

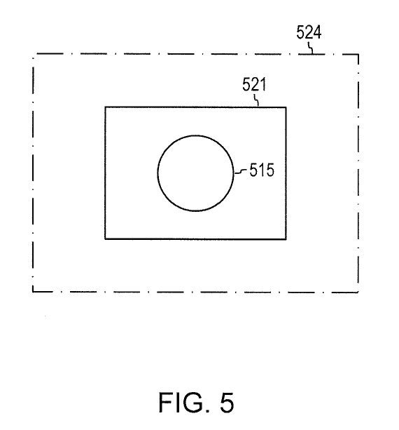

FIG. 5 depicts an embodiment of the present invention processing a mouse event 515 occurring in the viewer display environment. Here, the mouse event 515 occurs within the drawing window 521 in the desktop environment 508 of the viewer device 150. By manipulating the transparency of pixels in the drawing window 521 in proximity to the location of the mouse event 515, the manipulated pixels of the displayed drawn content may temporarily appear transparent or opaque, alternately permitting or preventing the mouse event 515 to be processed by applications or the operating system executing on the viewer device 150.

Embodiments of the present invention typically utilize a viewer device 150 that executes an operating system, such as the aforementioned MacOS X operating system. Contemporaneous operating systems include a graphical user interface component (GUI) that may include support for transparent windows.

In normal operation, many GUI windows are opaque, such that a window appearing in the GUI foreground (i.e., appearing higher in the desktop's Z-order) will obscure a second window appearing behind that window (i.e., a second window appearing lower in the desktop's Z-order). This mode of operation is useful in operations such as, e.g., word processing, where a user would prefer to focus on a single instance of presented content instead of being required to distinguish among multiple instances of presented content.

Contemporaneous GUI systems also allow for transparent or translucent (i.e., semi-transparent) windows, such that a window appearing in the GUI foreground will only partially obscure a second window appearing behind that window. The result appears to the user as a blend of the content of the foreground window and content of the second window appearing behind that window. This mode of operation is useful to the facilitation of contemporaneous operations, i.e., the operation of a user interface for an application that may normally obscure the display of other data of interest.

In addition to differences in display, operating systems may also process mouse events differently depending on whether the event occurs over a transparent window or a non-transparent (i.e., an opaque) window. For example, if a mouse event occurs in a location over an opaque window, the operating system will typically operate to pass that event to the executing application associated with that opaque window. For clarity, a mouse event occurs in a location “over” a window if the window is the foremost window in the window hierarchy by Z-order at the location of the mouse event.

In contrast, if the mouse event occurs in a location over a transparent window, the operating system may instead operate to pass that event “through” the transparent window to the executing application associated with the first opaque window below the transparent window. In other words, the mouse event is received by the executing application associated with the opaque window closest to the mouse event in the window hierarchy by Z-order, without regard for any transparent windows that may be closer by Z-order at the location of the mouse event.

Some embodiments of the present invention take advantage of this difference in system behavior to allow a viewer to interact with the applications and operating system executing on the viewer's computer even in the presence of remotely-originated content, such as graphical content communicated from a host computer. In short, these embodiments allow a viewer to interact with a computer displaying remotely-originated content as if the communicated content were not present on the viewer's computer, regardless of the opacity or transparency of the drawn content.

In these embodiments, a single pixel at the location of the mouse event 515 is cleared, causing the drawn content at that pixel to become temporarily transparent. Information about the mouse event 515 is then sent to the application associated with a non-transparent window appearing immediately below the drawing window 521, thereby allowing the viewer device 150 to receive the mouse event 515 at a different window. In effect, the viewer's mouse events bypass the drawn content to interact with the programs executing on the viewer's device.

In other embodiments, a single pixel at the location of the mouse event 515 is drawn, which may cause the drawn content at that pixel to become temporarily opaque. In this case, information about the mouse event 515 is sent to the application associated with the drawing window 521 and the mouse event 515 may even be used to draw new content in the drawing window 521. In effect, the viewer's mouse events are prevented from reaching the programs executing on the viewer's device, facilitating the viewer's interaction with drawn content.

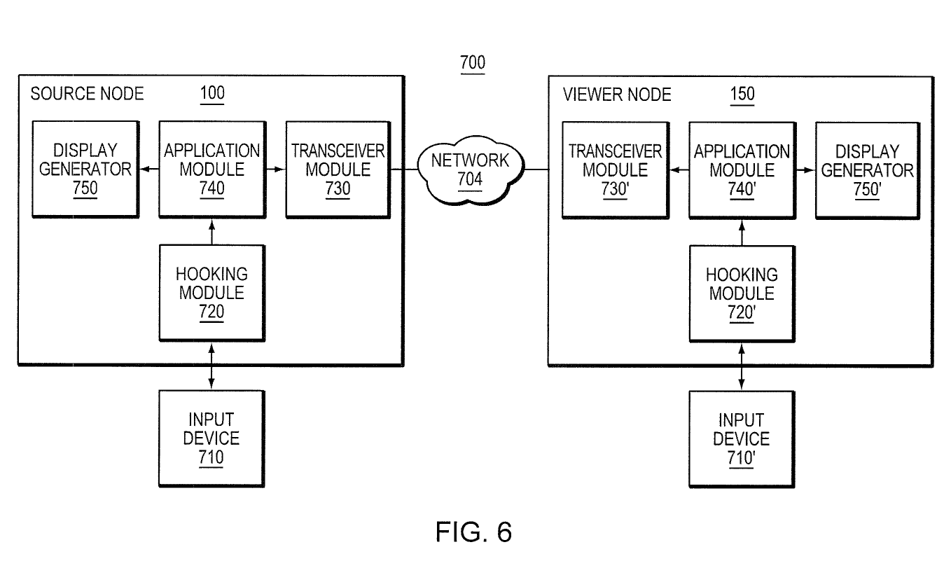

FIG. 6 depicts a block diagram of a system 700 for the selective manipulation of pixel transparency in proximity to a mouse event. In one embodiment, the system 700 includes a source device 100 in communication with a viewer device 150 through a network 704. Input device commands and position information are hooked at the source device 100 and transmitted to the viewer device 150 to be executed locally by the viewer device 150.

In one embodiment, the source device 100 includes an input device 710, a hooking module 720, a transceiver 730, one or more applications 740 (e.g., the screen sharing application), and a display generator 750. The hooking module 720 is in communication with the input module 710 and the application 740. The transceiver module 730 is in communication with the application 740 and the network 700. The application 740 is also in communication with the display generator 750. In one embodiment, the hooking module 720, the transceiver 730, and display generator 740 can be implemented as a software such as an application, a module, a service, a computer program, a software component, a web service, a web component, a web page, a library, a function, a script, an interpreted language, or any other type and/or form of executable instruction.

In one embodiment, the viewer device 150 includes an input device 710′, a hooking module 720′, a transceiver 730′, one or more applications 740′ (e.g., the screen sharing application), and a display generator 750′. The hooking module 720′ is in communication with the input module 710′ and the application 740′. The transceiver module 730′ is in communication with the application 740′ and the network 700′. The application 740′ is also in communication with the display generator 750′. In one embodiment, the hooking module 720′, the transceiver 730′, and display generator 740′ can be implemented as a software such as an application, a module, a service, a computer program, a software component, a web service, a web component, a web page, a library, a function, a script, an interpreted language, or any other type and/or form of executable instruction. The hooking module 720′ generally does not hook mouse commands from the viewer device 150 unless the viewer device 150 becomes the source device 100 during the screen sharing session.

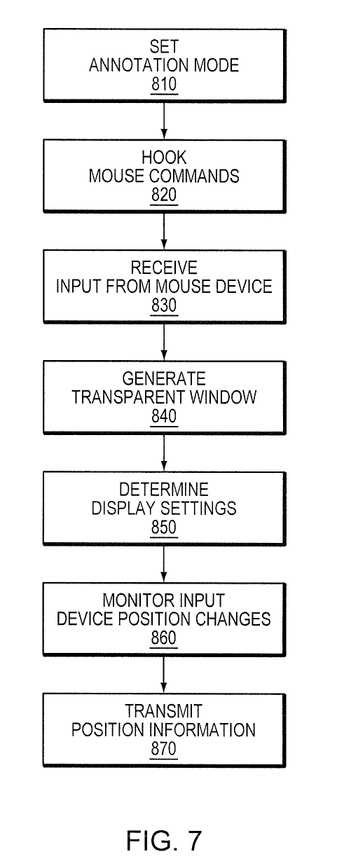

With reference to FIG. 7, and in brief overview, the operation of the system 700 of FIG. 6 is described. A user sets (step 810) the system 700 to the annotation mode. The system 700 begins hooking (step 820) mouse events and receiving (step 830) input from the input device 710. In response, the system 700 generates (step 840) a transparent window 524 and determines (step 850) the display settings of the source device 100. The system 700 continues to monitor (step 860) changes in the x/y position of the input device 710 and transmit (step 870) the position changes to the viewer device 150.

In one embodiment, the user selects a button 510 of the control panel 506 of the screen sharing application. In one embodiment, the selected button 510 provides the user with a plurality of tools capable of annotating the shared desktop environment 500. Upon selection of an annotation tool (e.g., the drawn content tool), the screen sharing application enters the annotation mode (step 810). In other embodiments, a keyboard shortcut, hotkey, voice command, or other input event can select the button 510 and activate the annotation mode.

After activation of the annotation mode, the screen sharing application begins hooking (step 820) mouse commands. In one embodiment, a WINDOWS programming command such as WH_MOUSE_LL is used to hook the mouse commands. The WH_MOUSE_LL hook command provides monitoring of mouse input events about to be posted in a thread input queue.

The hooking module 720 receives (step 830) input commands from the input device 710. In one embodiment, the input commands are click and hold events of the left mouse button along with other mouse event such as right clicks, left clicks, and mouse move events. In other embodiments, the input commands can include voice commands, pen clicks, and the like.

After receiving input, the screen sharing application positions (step 840) a substantially transparent window 524 directly below the drawn content. In one embodiment, a transparent window 524 is generated solely at the source device 100. In another embodiment, a transparent window is generated at the source device 100 and each viewer device 150. Said another way, in this embodiment the transparent window 524 is local to each system executing the screen sharing application. The substantially transparent window 524 is a layered window as defined in WINDOWS programming. For example, programming commands such as SetLayeredWindowAttributes and UpdatedLayeredWindowAttibute provide a means to control the transparency of the layered windows.

A determination module (not shown) of the application 740 determines (step 850) the display setting for the source device 100. In one embodiment, the display settings are read from a memory location or graphics card storing the requested information. In other embodiments, the information is inputted manually by the user of screen sharing application.

As the user of the source device 100 manipulates the input device, the screen sharing application monitors (steps 860) changes to the position of the input device 710. The x and y coordinates of the mouse are captured using the mouse hooking commands as previously described. In one embodiment, the hooking module 720 captures the position and changes in position of the input device 710.

In one embodiment, the transceiver 740 transmits (step 870) the input device 710 and its position to the each of the viewer devices 150 and through the network 704.

The described systems and methods can be used to implement a system for sharing screen data that allows several viewer systems to display the screen data from a single presenter system. This system is useful in a number of broadcast or “multicast” contexts and, in particular, it is useful in a conferencing context to allow multiple individuals to view the same graphical data during the conference.

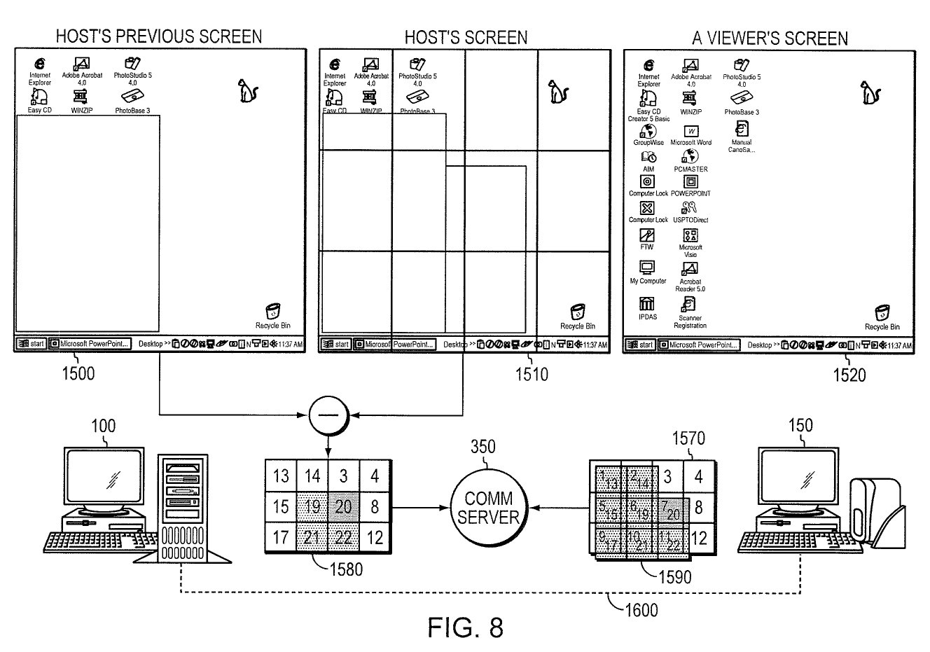

FIG. 8 depicts diagrammatically a system for sharing screen data. As shown in FIG. 8, a presenter system 100 monitors its screen state. In the embodiment shown in FIG. 8, the presenter system 100 subdivides its screen into twelve tiles, although any number of tiles may be used to fully represent the screen of the presenter system 100. In some embodiment the tiles are each the same size, that is, each tile represents the same number of screen pixels. In other embodiments, some of the tiles have sizes different from other tiles. In still other embodiments, a tile may overlap another tile or, as shown in FIG. 8, tiles may be non-overlapping.

As shown in FIG. 8, the presenter system's previous screen 1500 is represented by a first set of tiles (not shown), which are coded as a first set of data packets: 13, 14, 3, 4, 15, 6, 7, 8, 17, 10, 11, and 12. If the presenter system 100 possesses a transmission token, it transmits these twelve data packets to a communications server 350. As used herein, communications server refers to a device, process, or thread capable of transmitting data packets to a destination.

At a second point in time, the presenter system's screen 1510 has changed. The presenter system 100 identifies the particular tiles that have changed states, and creates a coded packet for each tile that has changed, i.e., data packets 19, 20, 21, and 22. If the presenter system 100 did not possess a transmission token but now receives one, the presenter system 100 will transmit the updated twelve data packets to the communications server 350, i.e., data packets 13, 14, 3, 4, 15, 19, 20, 17, 21, 22, and 12. If the source server has already transmitted the data packets representing the state of the previous screen 1500, then the presenter system 100 need only transmit to the communications server 350 data packets 19, 20, 21, and 22. In this manner, transmission of screen data between the presenter system 100 and the communications server 350 is performed in a bandwidth-adaptive manner.

In some embodiments, the presenter system 100 encrypts the data packets transmitted to the communications server 350. In other embodiments, the presenter system 100 compresses the data packets sent to the communications server 350. In still other embodiments, the presenter system 100 both encrypts and compresses the data packets.

In one embodiment, in addition to sending screen data through the communication server 350, the present invention can establish a virtual channel 1600 to transmit the drawn content 516 and input device position information to each of the viewer devices 150. In one embodiment, the virtual channel 1600 establishes a direct connection with each viewer device 150. In other embodiments, the virtual channel 1600 is established with the communication server 350, which in turn, broadcasts the drawn content 516 and the input device position information to each of the viewer devices 150.

In many embodiments, the communications server 350 maintains a copy of each tile that comprises the most recent state of the server device screen. In some embodiments, each tile is associated with a timestamp when transmitted to the communication server 350. In other embodiments, each tile is associated with a number that monotonically increases with each new tile transmitted to the communications server 350.

The communications server 350 composes an update for a viewer device 150 as often as the bandwidth of the network connecting the viewer device 150 to the communications server 350 allows. As shown in FIG. 8, the viewer's screen 1520 displays screen data from a point in time before the presenter's previous screen 1500. That is, the source server's display data has changed twice (represented by screen 1500 and screen 1510) since the last time the viewer device 150 has requested an update. Data packet array 150 shows the data packets comprising the screen data currently displayed by the viewer device 150. Data packet array 1590 depicts the data packets that the communications server 350 must transmit to the viewer device 150 in order to update the viewer's screen 320 to the state of the presenter's screen 310. As described above, the communications server 350 transmits metadata information to the viewer device 150 identifying eight data packets: data packets 13, 14, 15, 19, 20, 17, 21, and 22. In some embodiments, the metadata information explicitly identifies which tile replaces which other tile, perhaps by describing the position of the new tile. The communications server 350 then transmits the packets representing the new tiles to the viewer device.

In another embodiment, the communication server 350 responds to an update request from the viewer device 150 by transmitting to the viewer device 150 every data packet having a timestamp newer than the timestamp of the viewer's screen. In some of these embodiments, the communication server 350 does not fully receive and store a set of data packets comprising a screen update before sending the update to the viewer device 150. In these embodiments, the communications server 350 sets the timestamp for each packet identified by metadata information as comprising the screen update to the same value. Then, as data packets arrive the communications server 350 streams those packets to the viewer device 150.

In one particular embodiment, metadata information is formatted into packets and metadata packets are associated with monotonically increasing numbers. As described above, each metadata packet describes the set of tiles comprising the current screen display state. In this embodiment, the communications server 350 stores, for each viewer device 150, the number of the latest metadata packet that has been transmitted to that viewer device 150, as well as the set of all data packets that have been delivered to the viewer device. When the communications server 350 determines that it is time to send an update to a viewer device 150, or upon receiving a request from a viewer device 150 for a screen update, the communications service first determines if the latest metadata packet (that is, the metadata packet having the highest number associated with it) has been transmitted to the viewer device 150. If not, the communications server 350 transmits the most recent metadata packet to the viewer device 150. The communications server 350 also transmits the set of data packets identified by the metadata packet, unless a particular data packet has already been transmitted to the viewer device 150.

The previously described embodiments may be implemented as a method, system or article of manufacture using programming and/or engineering techniques to produce software, firmware, hardware, or any combination thereof. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.), a file server providing access to the programs via a network transmission line, wireless transmission media, signals propagating through space, radio waves, infrared signals, etc. The article of manufacture includes hardware logic as well as software or programmable code embedded in a computer readable medium that is executed by a processor. Of course, those skilled in the art will recognize that many modifications may be made to this configuration without departing from the scope of the present invention.

Although the present invention has been described with reference to specific details, it is not intended that such details should be regarded as limitations upon the scope of the invention, except as and to the extent that they are included in the accompanying claims.

What is claimed is:

1. A method for the remote display of drawn content, the method comprising:
creating, at a source device, a drawing window defining a region for the display of drawn content;
providing a copy of the drawing window to at least one viewer device;
observing a location of a system mouse event occurring at a viewer device; and
manipulating the transparency of at least one pixel in the drawing window at the source device at the location of the mouse event when the location of the mouse event is within the copy of the drawing window.

2. The method of claim 1 wherein the drawing window is at least semi-transparent.

3. The method of claim 2 wherein manipulating at least one pixel at the location of the mouse event comprises clearing a single pixel at the location of the mouse event.

4. The method of claim 3 wherein manipulating the transparency of at least one pixel at the location of the mouse event causes at least one pixel of the drawn content to become temporarily transparent.

5. The method of claim 4 further comprising providing information concerning the mouse event to a non-transparent window appearing immediately below the drawing window in Z-order.

7. The method of claim 2 wherein manipulating at least one pixel at the location of the mouse event comprises drawing a single pixel at the location of the mouse event.

8. The method of claim 7 wherein manipulating the transparency of at least one pixel at the location of the mouse event causes at least one pixel of the drawn content to become temporarily opaque.

9. The method of claim 8 further comprising providing information concerning the mouse event to the drawing window.

10. The method of claim 9 further comprising using the mouse event to draw new content in the drawing window.

11. A system for the remote display of drawn content, the system comprising:
a drawing window created at a source device, defining a region for the display of drawn content;
a copy of the drawing window provided to at least one viewer device;
a mouse event tap for observing a location of a system mouse event occurring at a viewer device; and
a display element for manipulating the transparency of at least one pixel in the drawing window at the source device at the location of the mouse event when the location of the mouse event is within the copy of the drawing window.

12. The system of claim 11 wherein the drawing window is at least semi-transparent.

13. The system of claim 12 wherein manipulating at least one pixel at the location of the mouse event comprises clearing a single pixel at the location of the mouse event.

14. The system of claim 13 wherein manipulating the transparency of at least one pixel at the location of the mouse event causes at least one pixel of the drawn content to become temporarily transparent.

15. The system of claim 11 wherein the mouse event tap further provides information concerning the mouse event to a non-transparent window appearing immediately below the drawing window in Z-order.

17. The system of claim 12 wherein manipulating at least one pixel at the location of the mouse event comprises drawing a single pixel at the location of the mouse event.

18. The system of claim 17 wherein manipulating the transparency of at least one pixel at the location of the mouse event causes at least one pixel of the drawn content to become temporarily opaque.

19. The system of claim 18 wherein the mouse event tap further provides information concerning the mouse event to the drawing window.

20. The system of claim 19 wherein the viewer device uses the mouse event to draw new content in the drawing window.

21. A computer-readable storage medium containing executable instructions, the set of instructions comprising:
instructions for creating, at a source device, a drawing window defining a region for the display of drawn content;
instructions for providing a copy of the drawing window to at least one viewer device;
instructions for observing a location of a system mouse event occurring at a viewer device; and
instructions for manipulating the transparency of at least one pixel in the drawing window at the source device at the location of the mouse event when the location of the mouse event is within the copy of the drawing window.
